(19) United States
(12) Patent Application Publication
(10) Pub. No.: US 2005/0223182 A1
(43) Pub. Date: Oct. 6, 2005

(54) User-configurable pre-recorded memory

(76) Inventor: Guobiao Zhang, Stateline, NV (US)

Correspondence Address: Guobiao Zhang, P.O. Box 6182, Stateline, NV, 89449-6182, US

(21) Appl. No.: 11/036,448

(22) Filed: Jan. 15, 2005

Related U.S. Application Data
(60) Provisional application No. 60/559,683, filed on Apr. 4, 2004.

(30) Foreign Application Priority Data
Nov. 15, 2004 (CN) 200410081241.X

(51) Int. Cl. H04K 1/00

(52) U.S. Cl. 711/163

(57) ABSTRACT

In a user-configurable pre-recorded memory (IC-PM), a user can select the files he wishes to access and therefore, only pay the copyright fees for the selected files. Three-dimensional memory (3D-M)-based UC-PM offers low cost and large capacity. More importantly, it provides impenetrable copyright protection and will enable a copyright distribution model, fair to both copyright owners and consumers.

### CROSS-REFERENCE TO RELATED APPLICATIONS

This application relates to a provisional application Ser. No. 60/559,683, “Improved Three-Dimensional Memory”, Filed Apr. 4, 2004. It also claims foreign priority of a Chinese P.R. patent application Serial No. 200410081241.X “Layout of Three-Dimensional Memory”, Filed Nov. 15, 2004.

### BACKGROUND

1. Technical Field of the Invention

The present invention relates to the field of integrated circuits, and more particularly to user-configurable pre-recorded memory.

2. Related Arts

Pre-recorded memory (PM) refers to the memory whose contents were written before reaching customer's hand. It is suitable for publishing, particularly for publishing copyrighted information (e.g. multimedia files, games, software, GPS maps, dictionary, etc.) Various types of non-volatile memory (NVM) can be used for PM, including mask ROM, write-once memory, and write-many-times memory.

The prior-art PM 22 (e.g. conventional mask ROM) may hold just one pre-recorded file (e.g. File D 28d). Apparently, a customer may want to access a large number of pre-recorded files (e.g. file A 28a, file D 28d). Accordingly, a large number of PM chips are needed to meet this demand (FIG. 1A).

As semiconductor technology advances, the PM capacity 23 increases dramatically recently. In the meantime, thanks to more efficient compression technologies, the customer needs 20 (on the PM capacity) increase at a much slower rate. As a result, the PM capacity 23 will soon exceed the customer needs 20 (after point A) (FIG. 1B).

With low cost and large capacity, three-dimensional memory (3D-M, referring to U.S. Pat. No. 5,835,396) is an ideal PM. It is anticipated that by 2008, a single 3D-M chip can reach 1 GB and above—equivalent to 200 songs, or 5 hrs of MPEG4 movies (all could be copyrighted). If full access is allowed for this many copyrighted files, excessive copyright fees will incur and the 3D-M chip carrying these files will become too expensive. In fact, a customer may just want limited access to the PM chip and pay copyright fees for the files he accesses (e.g. File A 28a, File D 28d, but not File B 28b, File C 28c of FIG. 1C). Thus, it is highly desired to develop a PM chip with limited access. Accordingly, the present invention discloses a user-configurable pre-recorded memory.

### OBJECTS AND ADVANTAGES

It is a principle object of the present invention to provide a pre-recorded memory with limited access.

It is a further object of the present invention for a customer to pay the copyright fees only for the files he wishes to access in a pre-recorded memory.

In accordance with these and other objects of the present invention, a user-configurable pre-recorded memory (UC-PM).

### SUMMARY OF THE INVENTION

With a large capacity, a single PM chip may contain a large number of copyrighted files. To access each of these copyrighted files, a copyright fee needs to be paid. Naturally, a customer does not wish to pay copyright fees for the files he does not wish to access. Accordingly, the present invention discloses a user-configurable pre-recorded memory (UC-PM). In a UC-MPM, a user can select the files he wishes to access and therefore, only pay copyright fees for these selected files. Take music chip (i.e. a PM chip containing copyrighted songs) as an example. For a music UC-PM chip as-sold, there is little music access (e.g. a user may be able to listen to a song several times as trial). When a user decides to own a song, he will buy an access code from the copyright owner (e.g. through internet or telephone). After the access code is inputted into the chip, access will be allowed to said song.

Three-dimensional memory (3D-M) is particularly suitable for UC-PM. Its large capacity and low cost are ideal for pre-recorded contents. Moreover, the access control circuit of the UC-PM can be easily integrated underneath the 3D-M array, which cannot be tampered with. Together with decryption engine and digital-to-analog converter, 3D-M-based UC-PM can provide excellent access control and impenetrable copyright protection for the information it carries.

UC-PM, more particularly 3D-M-based UC-PM, will enable a new distribution model for copyrighted information. Because an UC-PM provides impenetrable copyright protection, it is feasible to sell an UC-PM chip at a very low price or nearly free. As a customer purchases more and more copyrighted files on the chip, the chip manufacturer will recoup the IC cost. This is unlikely for the conventional PM (e.g. CD, DVD), standalone NVM. Because they offer little copyright protection, a customer needs to pay copyright fees for all copyrighted files on the PM (even for files he has little interest) and these fees have to be paid upfront (i.e. when a customer purchases the PM).

The present invention also provides several improved diode-based memory (in this disclosure, diode refers to any two-terminal device that enhances the current flow in one direction and blocks the current flow in the other, referring to U.S. Pat. No. 5,835,396): narrow-line diode-based memory and wide-word-line diode-based memory. Both concepts can be applied to diode-based 3D-M.

In a narrow-line diode-based memory, the line pitch of the diode memory array can be smaller than the gate poly pitch of the transistor memory array. This is because the transistor scaling (limited by many more factors, e.g. lithography, gate material, gate dielectric and channel/source/drain engineering) is more stringent than the diode (more or less limited by lithography only). The narrow-line diode-based memory is particularly suitable for 3D-M because diodes in the 3D-M and transistors in the substrate are formed in separate manufacturing steps and can be optimized independently.

In a wide-word-line diode-based memory, the word line is preferably wider than bit line. This is because: A) the yield of diode-based memory is more susceptible to word-line defects than bit-line defects (it is much easier to correct bit line errors); B) during read, a word line needs to provide current to multiple bit lines and therefore, preferably has a lower sheet rho.

### BRIEF DESCRIPTION OF THE DRAWINGS

FIG. 1A illustrates relative sizes of pre-recorded memory (PM) capacity and customer needs in prior arts; FIG. 1B illustrates the growth trend of the PM capacity; FIG. 1C illustrates relative sizes of PM capacity and customer needs in the near future;

FIG. 2A illustrates a first preferred usage model of a user-configurable PM (UC-PM); FIG. 2B illustrates a second preferred usage model of the UC-PM;

FIG. 3 is a block diagram of a preferred UC-PM;

FIG. 4A illustrates a first preferred read-out block in the UC-PM; FIG. 4B illustrates a second preferred read-out block;

FIG. 5A illustrates a business model based on which a consumer gets an access code from the copyright owner; FIG. 5B illustrates a first preferred access configuration block used in the UC-PM; FIG. 5C illustrates a second preferred access configuration block;

FIG. 6 illustrates a prior-art implementation of UC-PM;

FIG. 7A illustrates a three-dimensional memory (3D-M); FIG. 7B illustrates a first preferred 3D-M-based UC-PM; FIG. 7C illustrates a second preferred 3D-M-based UC-PM; FIG. 7D illustrates a third preferred 3D-M-based UC-PM;

FIG. 8 illustrates a preferred 3D-M with integrated PWM converter;

FIG. 9A is a cross-sectional view of a preferred narrow-line 3D-M; FIG. 9B is its layout view;

FIG. 10 is a layout view of a preferred wide-word-line diode-based memory.

### DETAILED DESCRIPTION OF THE PREFERRED EMBODIMENT

Those of ordinary skills in the art will realize that the following description of the present invention is illustrative only and is not intended to be in any way limiting. Other embodiments of the invention will readily suggest themselves to such skilled persons from an examination of the within disclosure.

1. User-Configurable Pre-Recorded Memory (UC-PM)

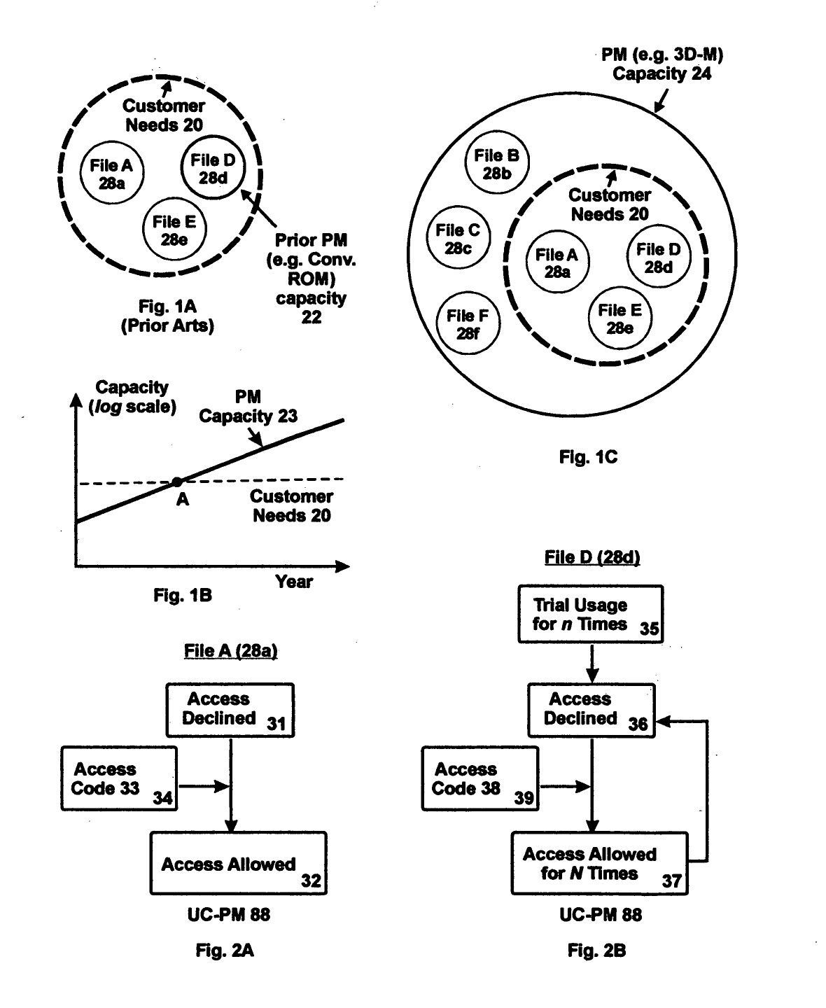

In a UC-MPM, a user can select the files he wishes to access and therefore, only pays copyright fees for the selected files. FIGS. 2A-2B illustrate two preferred usage models of the UC-PM. Assume this UC-PM chip 88 carries pre-recorded songs (music files). In the preferred embodiment of FIG. 2A, initially there is no access to the music files stored in the UC-PM 88 (step 31). After inputting an access code 33 (step 34) to the chip, the user can listen to the songs associated with this access code 33 (step 32).

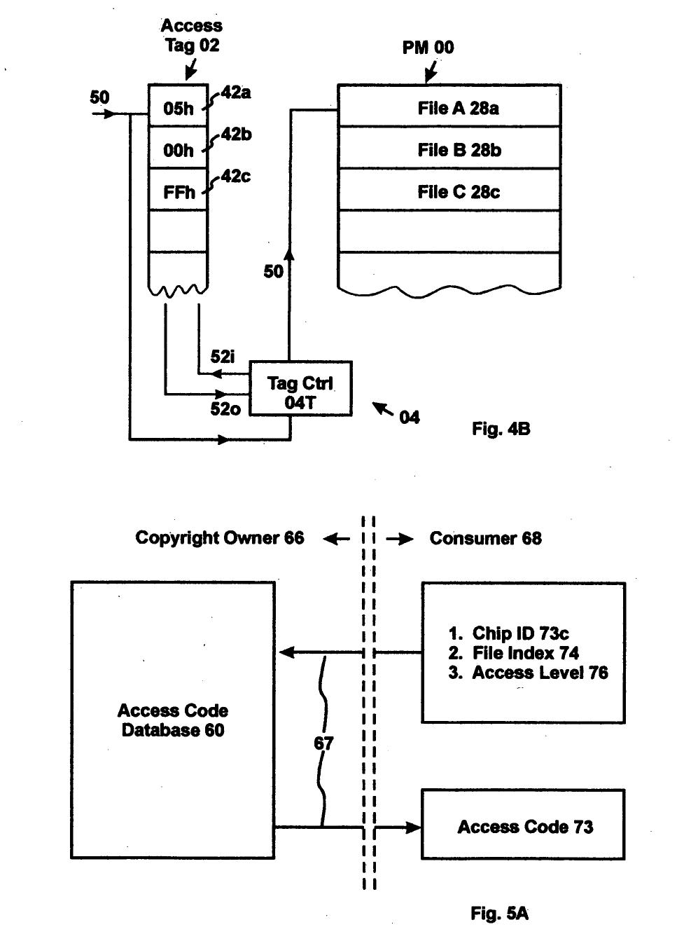

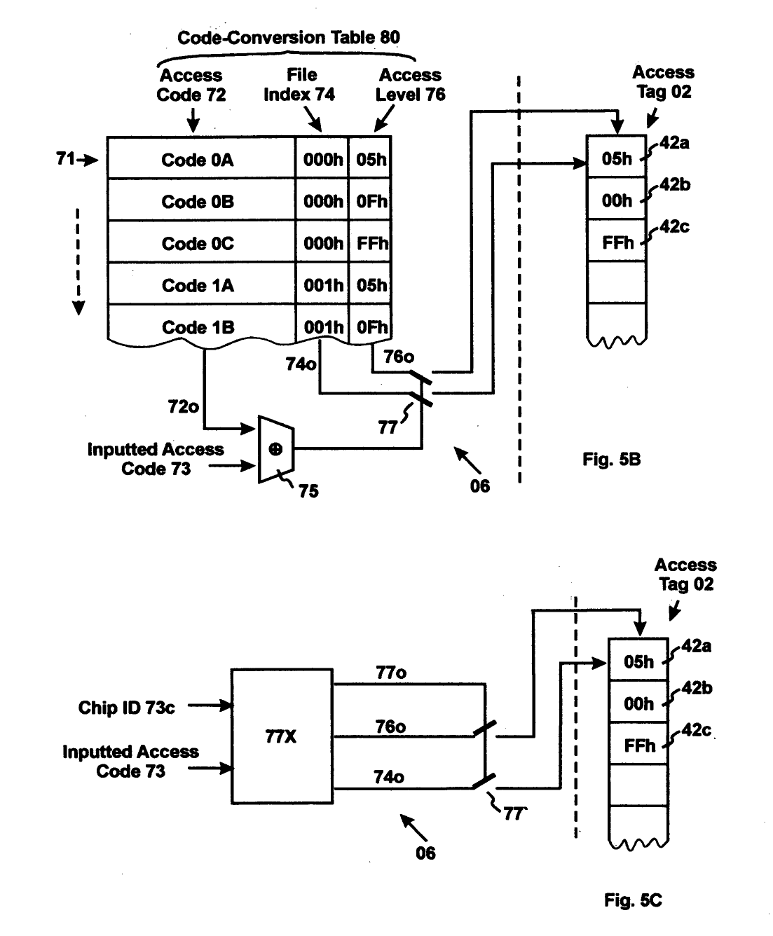

In the preferred embodiment of FIG. 2B, initially the UC-PM 88 allows a user to trial-listen to a song for n times (step 35). After this trial period, access becomes declined (step 36). Only after an access code 38 is input into the chip (step 39), certain access to the associated music files is allowed (step 37). Depending on the access code 38, different access levels (i.e. various N time of accesses) can be allowed. For example, for access code A, a song can be listened to 5 times (before its access become disabled); for access code B, a song can be listened to unlimited number of times . . . (referring to FIG. 5A for more details).

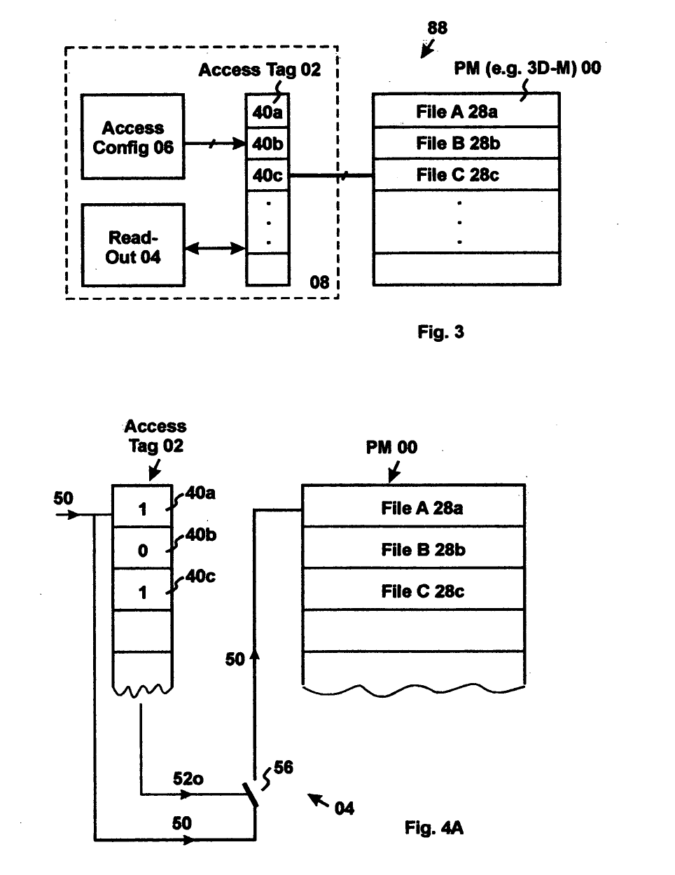

Referring now to FIG. 3, a block diagram of a preferred UC-PM 88 is illustrated. It is comprised of a PM block 00 and an access control block 08. The PM block 00 stores the pre-recorded contents. It could be a 3D-M array. The access control block 08 controls access to these pre-recorded contents. It further comprises an access tag block 02, a read-out block 04 and an access configuration block 06. The access tag block 02 contains the accessibility information for each file (e.g. 40a for File A 28a, 40b for File B 28b . . . ). The read-out block 04 reads out selected file based on its accessibility information and also updates the access tag 02. The access configuration block 06 configures the access tag 02 based on the access code inputted by the user. FIGS. 4A-5B explain these blocks in more details.

FIG. 4A illustrates a first preferred read-out block 04. It corresponds to the first usage model of FIG. 2A. The PM block 00 and the access tag block 02 can be addressed by a file index 50. In this preferred embodiment, the accessibility information is a single bit—accessibility bit. If the accessibility bit is “1” (e.g. 40a), access to the corresponding file (e.g. 28a) is allowed; otherwise (e.g. 40b), access is declined (e.g. for 28b). During read-out, the access tag 02 is accessed first. If its output 52o is “1”, switch 56 is closed, the file index 50 is sent to the PM block 00 and the corresponding file is read out; otherwise, no file is read out.

FIG. 4B illustrates a second preferred read-out block 04. It corresponds to the second usage model of FIG. 2B. Different from FIG. 4A, the accessibility information is the remaining number of allowed accesses and it comprises 8 bits in this preferred embodiment. For example, “05h” (in 42a) means there are 5 times of accesses remaining to File A 28a; “00h” (in 42b) means there is no (0 times) access to File B 28b; “FFh” (in 42c) means there is unlimited access to File C 28c.

During read-out, the access tag 02 is accessed first. If its output 52o is larger than “00h”, the file index 50 is sent over to the PM block 00 and the corresponding file is read out; otherwise, no file is read out. In this preferred embodiment, the read-out block further comprises a tag control block 04T, which updates the value of the access tag 02 after each read-out. When the access tag output “00h”<52o<“FFh”, the tag control 04T decreases 52o by 1, and writes 52i (52i=52o−1) back to the access tag 02. Under other circumstances, the tag control 04T does not vary the access tag 02.

FIG. 5A illustrates a business model based on which a user 68 gets an access code from the copyright owner 66. When a user 68 decides to get access to a file, he connects the PM chip 88 with a computer. The computer gets its chip ID 73c and displays a list of all files and their various access levels (e.g. number of allowed accesses). The user selects the desired files/access levels and send this information (i.e. chip ID 73c, file index 74, and access level 76), as well as payment for copyright fees, to the copyright owner 66 through internet or telephone 67. On the other hand, the copyright owner 68 keeps an access-code database 60. It could be either in look-up table or based on certain proprietary algorithm. Note that access code should be unique for different chips, different files and different access levels, namely,
Access Code=Function (chip ID, file index, access level). Eq. (1)
The copyright owner 66 returns an access code 73 to the user, which can be used to enable access to the selected files.

FIG. 5B illustrates a first preferred access configuration block 06 used in the UC-PM. It configures the access tag 02 based on the access code 73 inputted by the user. Its major component is a code-conversion table 80, which provides a one-to-one correspondence between access code and file/access level. The code-conversion table 80 comprises a number of entries 71. Each entry 71 contains an access code 72, a file index 74 and an access level 76. For example, for file index 000h, the access code for 5 times (“05h”) of accesses is “Code 0A”; the access code for 15 times (“0Fh”) is “Code 0B”; the access code for unlimited access (“FFh”) is “Code 0C” (here, “FFh” is singled out for unlimited access). Because access codes are different for different chips, they are preferably stored in an electrically programmable memory on the UC-PM chip.

When an access code 73 is inputted by the user, the access configuration block 06 searches through the code-conversion table 80. If the output 720 from the table 80 matches the inputted access code 73 (through the NAND gate 75), switches 77 are closed. The file index 74o is then used as address for the access tag 02 and access level 76o is written into the access tag 02.

As disclosed in FIG. 5A, access codes can also be created by proprietary algorithm. Accordingly, from Eq. (1),
File index 74o=FunctionA (Access code 73, Chip ID 73c); Eq. (2)
Access level 76o=FunctionB (Access code 73, Chip ID 73c). Eq. (3)
This can be implemented by a hardware such as access-extraction engine 77X (FIG. 5C), which performs the above functions, i.e. Eqs. (2)-(3). The access-extraction engine 77X further comprises a validity bit 77o. It will flag when the inputted access code 73 is not valid. Note that chip ID 73c is different for different chips. It is preferably stored in an electrically programmable memory on the UC-PM chip.

FIG. 6 illustrates a prior-art implementation of UC-PM 90. It comprises two PM chips 92a, 92b and an access control chip 94. PM chips 92a, 92b carry the pre-recorded contents and the access control chip 94 performs the function of the access control block 08. Because discrete chips are used and the PM chips 92a, 92b do not have any access control by themselves, pirates may steal copyrighted information directly from PM chips 92a, 92b. This is not desirable for copyright owners.

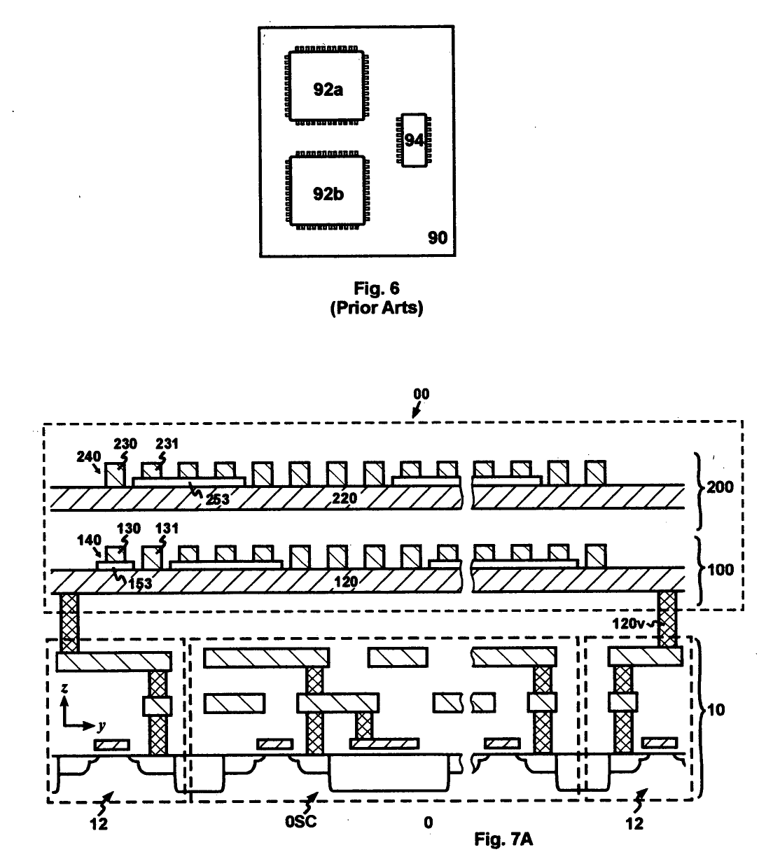

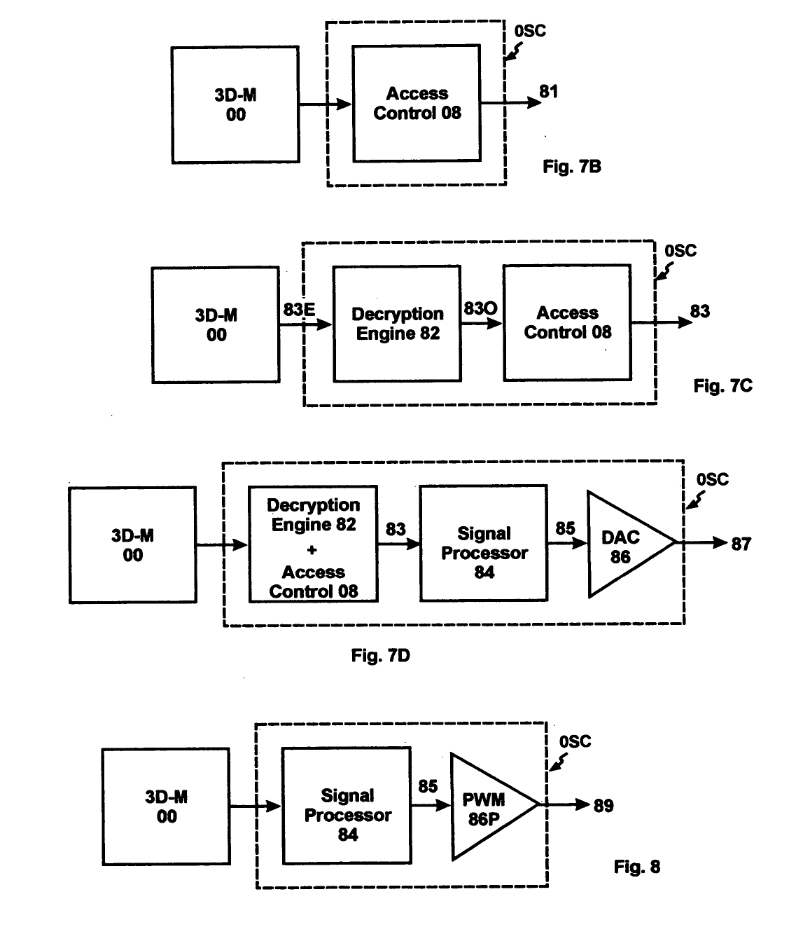

FIG. 7A illustrates a three-dimensional memory (3D-M). In this 3D-M 00, two memory levels (100, 200) are stacked on top of each other and then substrate 0. Each memory level comprises address lines (word lines 120, 220 . . . ; bit lines 130, 131, 230, 231 . . . ) and memory cells (140, 240 . . . ). Memory level 100 connects with substrate 0 through inter-level vias 120v. 3D-M could be either electrically programmable 3-D memory (EP-3DM, e.g. write-once 3D-M, 3D-flash, 3D-RAM); or non-electrically programmable 3-D memory (NEP-3DM). A typically example of NEP-3DM is 3-D mask-programmable memory (3D-MPM), which is illustrated in FIG. 7A. Configuration dielectric 153, 253 defines the digital information at each cell location. Its existence (e.g. cell 140) represents digital “0”; its absence (e.g. cell 240) represents digital “1”. With low cost and large capacity, 3D-M is ideal for PM. More importantly, 3D-M, particularly 3D-MPM, has excellent integratibility. Because the 3D-M 00 does not occupy substrate 0 (except its decoder 12), its substrate real estate can be used to build substrate circuit 0SC, which can perform a variety of functions and is located underneath the 3D-M array 00. This excellent integratibility offers 3D-M many advantages over conventional (2D) memories, especially in the area of copyright protection. Referring now to FIG. 7B, a first preferred 3D-M-based UC-PM is illustrated. Its access control block 08 is integrated into substrate circuits OSC. Located underneath the 3D-M array 00, the access control block 08 cannot be tampered with. As a result, this preferred embodiment provides excellent access control.

Due to its excellent integratibility, 3D-MPM is particularly ideal for UC-PM. For 3D-MPM, pirates might steal copyrighted information by reverse-engineering the configuration-dielectric patterns (153, 253 . . . ) (using means such as de-layering). To prevent this from happening, the data stored in the 3D-M array 00 are preferably encrypted, as is the case for FIG. 7C. Its substrate circuit 0SC further comprises a decryption engine 82. Output data 83E from the 3D-M array 00 (i.e. encrypted data) are converted into the original contents 830 by the decryption engine 82. The access control block 08 controls access to individual file. Because both access control block 08 and decryption engine 82 are located underneath the 3D-M array 00, they cannot be tampered with. Accordingly, this preferred embodiment provides excellent access control and copyright protection.

Another copyright concern is that pirates might digitally copy the output signals from the PM chip (e.g. the output signals 83 in FIG. 7C are digital and can be easily copied). To address this concern, at least one output signal, more desirably, multimedia output (e.g. audio and/or video output) from the PM chip should be in analog form, which can be directly fed into an amplifier, earphone and/or display. Even though pirates might re-digitize these analog signals, the signal quality will be degraded.

This copyright-protection scheme is implemented in the preferred embodiment of FIG. 7D. Besides access control 08 and decryption engine 82, its substrate circuit OSC further comprises a signal processor 84 and a digital-to-analog converter (DAC) 86. The signal processor 84 converts the pre-recorded contents 83 (usually compressed) into un-compressed digital format 85. Typical signal processors 84 include audio decoders (e.g. mp3 decoder), image decoders (e.g. jpeg decoder), and video decoders (e.g. mpeg decoder). Then DAC 86 converts these digital data 85 into analog signals 87, e.g. analog music, image, and/or video signals. Because signal processor 84 and DAC 86 are located underneath the 3D-M array 00, they cannot be tampered with. Thus, impenetrable copyright protection can be achieved. Accordingly, this preferred embodiment provides a single-chip solution for content storage, playback and protection—the 3D-M 00 is the carrier for pre-recorded contents and the substrate circuit OSC provides decryption, access control and signal conversion functions. Its commercial potentials are boundless.

The analog signals in the conventional sense are in the voltage domain, i.e. the amplitude of signal voltage is analog. In fact, analog signals could be in the time domain, i.e. the duration of the signal is analog. This is commonly known as pulse-width modulation (PWM). PWM becomes a common output form for multimedia signals recently. Accordingly, the present invention discloses a 3D-M with integrated PWM converter. As illustrated in FIG. 8, the digital data 85 are fed into a PWM converter 86P, which is a special-type of DAC 86, and converted into PWM signals 89. Apparently, the substrate circuit OSC may also include other circuits such as decryption engine 82 and access control 08. The 3D-M with integrated PWM converter can also offer excellent access control and impenetrable copyright protection.

Finally, a new distribution model of copyrighted information will be discussed. Because an UC-PM, more particularly 3D-M-based UC-PM, provides impenetrable copyright protection, it is feasible to sell an UC-PM chip at a very low price or nearly free. As a customer purchases more and more. copyrighted files on the chip, the chip manufacturer will recoup the IC cost. This is unlikely for the conventional PM (e.g. CD, DVD, standalone NVM). Because they offer little copyright protection, a customer needs to pay copyright fees for all contents thereon, even for contents he has little interest. Moreover, these fees have to be paid upfront, i.e. when a customer purchases the PM. Apparently, UC-PM will provide a copyright distribution model, fair to both copyright owners and consumers.

2. Narrow-Line Diode-Based Memory

Currently, transistors (CMOS) are the bottleneck for technology scaling. Its scaling involves many factors: lithography, gate material, gate dielectric material, channel/source/drain engineering and others. On the other hand, diode scaling is much simpler: it is more or less limited by lithography only. Accordingly, diode-based memory follows different scaling law than the transistor-based memory:

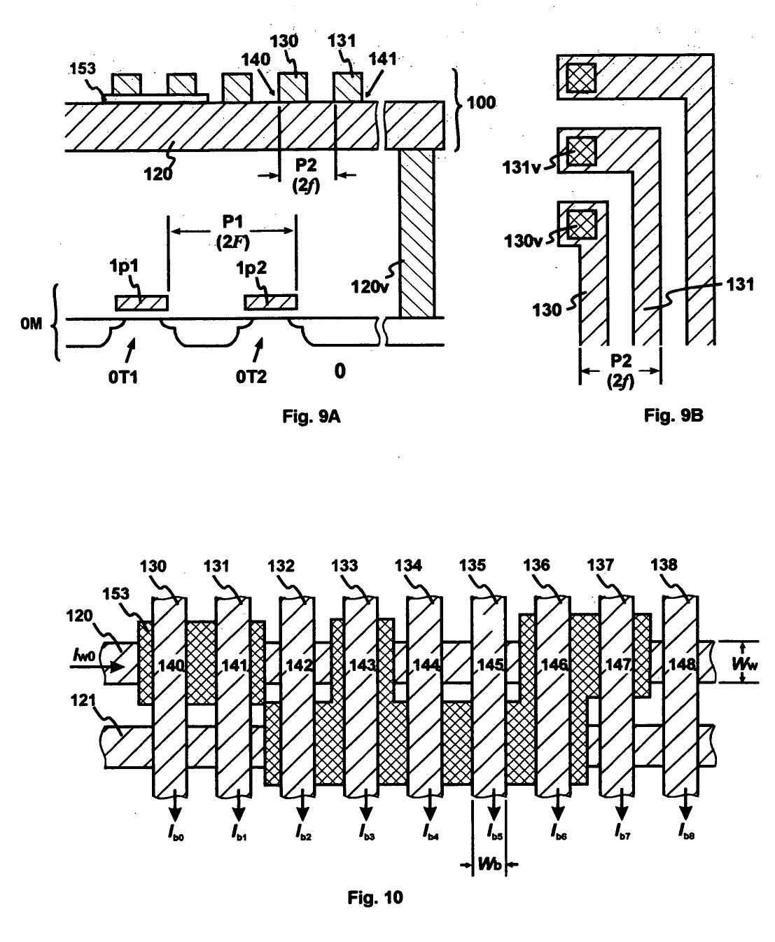

1) its feature size f (half-pitch between address-selection lines, referring to FIG. 9A) could be much smaller than the transistor feature size F (half-pitch between gate poly, referring to FIG. 9A). For example, diode memory may use f=60 nm technology, when transistor memory still uses F=90 nm technology.

2) its scaling can occur at a much faster rate than transistor. For example, it may take two years to scale diodes for one generation, while it will take three years for transistors.

In sum, the diode-based memory will have a large density than transistor-based memory and this density gap will becomes even larger.

Diode-based memory can be formed either in the substrate together with transistors (like a conventional embedded memory), or on top of the substrate as three-dimensional memory (3D-M). For diode-based 3D-M, because transistor 0T1, 0T2 (in substrate 0, FIG. 9A) and diodes 140, 141 (on top of substrate 0) are formed in separate manufacturing steps, diodes can be scaled independently. This can greatly improve the 3D-M density. FIGS. 8A-8B discloses a preferred narrow-line diode-based 3D-M.

FIGS. 9A-9B are cross-sectional and layout views of a preferred narrow-line diode-based 3D-M. Its memory level 100 comprises a plurality of memory cells 140, 141 (with configuration dielectric 153), word line 120 and bit lines 130, 131. Its substrate 0 comprises a functional transistor-based memory 0M, which further comprises transistors 0T1, 0T2. The 3D-M feature size F is half of the pitch P2 (=2f) between the address-selection lines 130, 131. The transistor feature size F is half of the pitch P1 (=2F) between the gate poly 1p1, 1p2 of functional transistors. In this preferred embodiment, all substrate circuits follow the F-design rule, while all 3D-M array follows the f-design rule. Because f can be much smaller than F, this type of 3D-M is referred to as narrow-line diode-based 3D-M. Apparently, this concept can be applied to any other diode-based memory.

The inter-level via 120v may use f technology (i.e. the size of the inter-level via is f), or F technology (i.e. the size of the inter-level via is F). To use the F technology, the address-selection lines 130, 131 need to be bent for an angle so that larger via spacing (F instead of can be accommodated in the layout.

3. Wide-Word-Line Diode-Based Memory

To improve yield, the present invention discloses a wide-word-line diode-based memory. To be more specific, the width W_{w} of its word lines 120, 121 is larger than the width W_{b} of its bit lines 130, 131 . . . (W_{w>W}_{b}) (FIG. 10). This is mainly due to the fact that the yield of diode-based memory is more susceptible to word-line defects than bit-line defects. The reason is as follows: during read-out, a single word line is addressed in a unit array and a number of cells on said word line are read out at the same time. If the word line has a defect, all cells thereon cannot be read out. On the other hand, if the bit line has a defect, there would be a single error in the read-out and this can be corrected by error-correction circuit (ECC), e.g. ECC based on Hamming code (referring to FIG. 24 of U.S. Pat. No. 6,717,222. Here, for example, bit lines 130-137 could be data bit lines, and bit line 138 could be error-correction bit line.) To improve yield, wide word lines are preferred for diode-based memory, because a wider line has less defect.

Wide word line can also prevent excessive word-line voltage drop during read-out. During read-out, a single word line 120 is addressed in a unit array and a number of cells are read out at the same time. Accordingly, the word line needs to provide current for all bit lines under read, i.e. I_{w0}=I_{b2}+I_{b4}+I_{b5}+I_{b8} (in FIG. 10, I_{b0}, I_{b1}, I_{b3}, I_{b6}, I_{b7}=0). In a real circuit, the number of bit lines can easily reach 10⁴. As a result, the current in word line can be much larger than bit line. To avoid excessive voltage drop thereon, the word line preferably has a low sheet-rho. Methods to lower the sheet-rho include: A) use a wide word line; B) use a thick word line; C) word line uses a more conductive material (e.g. metal or metallic alloy). Apparently, any or a combination of above methods can be used.

While illustrative embodiments have been shown and described, it would be apparent to those skilled in the art that may more modifications than that have been mentioned above are possible without departing from the inventive concepts set forth therein. The invention, therefore, is not to be limited except in the spirit of the appended claims.

1. A user-configurable pre-recorded memory, comprising:
a pre-recorded memory storing a plurality of pre-recorded files; and
an access control block controlling access to each of said pre-recorded files.

2. The user-configurable pre-recorded memory according to claim 1, wherein said access control block further comprises an access tag block, said access tag block containing accessibility information for said pre-recorded files.

3. The user-configurable pre-recorded memory according to claim 2, wherein said accessibility information contains an accessibility bit or the remaining number of allowed accesses.

4. The user-configurable pre-recorded memory according to claim 2, wherein said access control block further comprises an access configuration block, said access configuration block configuring said access tag based on an inputted access code.

5. The user-configurable pre-recorded memory according to claim 4, wherein said access configuration block further comprises a code-conversion table, said code-conversion table further comprising a plurality of access codes and the associated file index/access levels.

6. The user-configurable pre-recorded memory according to claim 4, wherein said access configuration block further comprises an access-extraction engine.

7. The user-configurable pre-recorded memory according to claim 1, wherein said access control block further comprises a chip ID.

8. The user-configurable pre-recorded memory according to claim 1, further comprising an electrically programmable memory for storing a chip ID or a plurality of access codes.

9. The user-configurable pre-recorded memory according to claim 1, wherein:
said pre-recorded memory is a three-dimensional memory (3D-M); and
said user-configurable pre-recorded memory further comprises a substrate circuit underneath said 3D-M.

10. The user-configurable pre-recorded memory according to claim 9, wherein said access control block is a portion of said substrate circuit.

11. The user-configurable pre-recorded memory according to claim 9, wherein
at least a portion of said pre-recorded files are encrypted; and
said substrate circuit further comprises a decryption engine.

12. The user-configurable pre-recorded memory according to claim 9, wherein said substrate circuit further comprises a digital-to-analog converter.

13. The user-configurable pre-recorded memory according to claim 12, wherein said digital-to-analog converter is a pulse-width modulation converter.

14. A three-dimensional memory with integrated pulse-width modulation (PWM) converter, comprising:
a substrate circuit comprising a PWM converter;
a three-dimensional memory (3D-M) array stacked on top of said substrate circuit, said PWM converter located underneath said 3D-M array; and
a plurality of inter-level vias connecting said 3D-M array with said substrate circuit.

15. The three-dimensional memory with integrated PWM converter according to claim 14, wherein said substrate circuit further comprises a circuit block selected from a group consisting of access control block, decryption engine, signal processor and digital-to-analog converter.

16. A diode-based memory, comprising:
a substrate with a plurality of functional transistors formed thereon; and
a diode-based memory array comprising a plurality of diode-based memory cells and address-selection lines.

17. The diode-based memory according to claim 16, wherein said diode-based memory array is a three-dimensional memory (3D-M) array; and
said functional transistors are located underneath said 3D-M array.

18. The diode-based memory according to claim 16, wherein the minimum poly gate pitch of said functional transistors is larger than the minimum line pitch of said address-selection lines.

19. The diode-based memory according to claim 16, further comprising at least one diode-based memory unit array, said unit array further comprising a plurality of word lines and bit lines, a single word line providing current to selected ones of said bit lines during read-out, wherein
said word line is wider than said bit line; and/or
said word line has a lower sheet rho than said bit line.

20. The diode-based memory according to claim 19, wherein
said word line is thicker than said bit line; and/or
said word line comprises a material more conductive than said bit line.
